(19) United States
(12) Patent Application Publication
(10) Pub. No.: US 2025/0312821 A1
(43) Pub. Date: Oct. 9, 2025

(54) Self-Resonant Piezoelectric Assembly and Efficient Electronic Circuit for Producing Ultrasound

(71) Applicant: William L. Puskas, New London, NH (US)

(72) Inventor: William L. Puskas, New London, NH (US)

(21) Appl. No.: 18/628,781

(22) Filed: Apr. 7, 2024

(51) Int. Cl. B06B 1/02

(52) U.S. Cl. CPC B06B 1/023; B06B 2201/55

(57) ABSTRACT

An apparatus which is an array of multiple series connected ultrasound transducers forming assemblies having positive and negative reactive impedance frequency regions that resonate and that are driven by an efficient electronic circuit at or sweeping around the resonance.

This application claims priority to provisional patent application No. 63/495,106 filed Apr. 9, 2023.

### BACKGROUND

Transducer arrays for applications such as ultrasonic cleaning, sonochemistry, megasonics, cell destruction, etc. typically consist of a number of similar transducers, e.g., Langevin transducers, piezoelectric ceramic elements or radial mode piezoelectric transducers connected in parallel and driven at or sweeping around the resonant frequency or anti-resonant frequency of the parallel transducer array. The driving source is usually an efficient electronic circuit such as a bridge circuit or other square wave type generator for high efficiency and containing reactive components on its output. The paralleled transducer array should be driven by an approximately sinusoidal shaped waveform at (and often around the resonant frequency or anti-resonant frequency for sweeping frequency applications) its resonant frequency or anti-resonant frequency. Also included in the prior art are series connected similar transducers of approximately the same frequency to lower the total capacitance of an array of transducers. Since the transducer array is self-resonant at the resonant frequency and at the anti-resonant frequency it looks resistive. Therefore, reactive impedances, e.g., capacitance and/or inductance (sometimes in the form of leakage inductance of an output isolation transformer) are incorporated between the efficient electronic circuit and the transducer array to produce the needed approximately sinusoidal shaped waveform from the typical approximately square wave shaped waveform of the efficient electronic circuit driving source. The prior art has produced good products for many years using this technology. Its disadvantages are the cost and tuning stability of the reactive impedances inserted between the parallel transducer array and the driving efficient electronic circuit and the need to operate at or around resonance or anti-resonance when a frequency or frequency bandwidth between these two frequencies often produces better results.

The present invention eliminates or greatly reduces the need of reactive impedances between the efficient electronic circuit and a parallel transducer array and forms a new resonant circuit at a frequency located between the resonant frequency and the anti-resonant frequency of a transducer for optimum performance in many applications. With this invention it is possible to produce ultrasonic and megasonic sound waves in liquids at a lower cost and often with better performance than was previously available.

Also available in the prior art are multiple frequency parallel arrays of similar transducers e.g., Langevin transducers, piezoelectric ceramic elements (typically used for megasonic applications) or radial mode piezoelectric transducers. The multiple frequencies are typically obtained from overtones or harmonics of the parallel array. For Langevin transducers and radial mode piezoelectric transducers these overtones are typically about integer multiples of the transducer's fundamental resonant frequency. For similar paralleled piezoelectric ceramic elements (typically used in megasonic transducer arrays) the overtones or harmonics are typically about odd integer multiples of the array's fundamental frequency. Each individual frequency in a multiple frequency array has the disadvantages that properly designed reactive components must be inserted between the efficient electronic circuit and the parallel transducer array to produce an approximately sinusoidal shaped waveform at frequencies such as resonance or anti-resonance and at their overtones or harmonics. Further, this reactive network (LC) is different for each of the multiple frequencies.

The present invention eliminates or greatly reduces the need of capacitive or inductive components between the efficient electronic circuit and the parallel multiple frequency transducer array and forms a new resonant circuit(s) at each of the multiple frequencies. Each of these resonant circuits is located between the resonant frequency and the anti-resonant frequency of the appropriate overtone or harmonic of the multiple frequency transducer for optimum performance at each multiple frequency in many applications. With this invention it is possible to produce multiple frequency ultrasonic and megasonic sound waves in liquids at a lower cost and often with better performance than was previously available.

### SUMMARY

### Definitions

“Ultrasonics or Ultrasound” are sound waves above the range of human hearing, typically 18 kHz to above 10 MHZ.

“Megasonics” the higher end of the ultrasonics frequency range, typically 350 kHz to over 10 MHZ.

“Similar transducers” are transducers e.g., Langevin transducers, piezoelectric ceramic elements or radial mode piezoelectric transducers each designed and built with the same parts except for normal production tolerances, in some cases parts are selected to reduce the variations within a batch of transducers.

“Similar piezoelectric ceramics” are virtually the same parts except for normal production tolerances, in some cases parts are selected to reduce the variations within a batch of ceramics.

“Component” is a network containing one or more transducers, e.g., Langevin transducers, piezoelectric ceramic elements or radial mode piezoelectric transducers, and may have one or more passive elements (e.g., capacitors, inductors, resistors, transformers) in parallel and/or series with the one or more transducers.

“Assembly” is two components with different frequency and impedance characteristics each designed to have frequency and impedance characteristics according to the invention and connected in series.

“Similar assemblies” are assemblies each designed and built with the same parts except for normal production tolerances, in some cases parts are selected to reduce the variations within a batch of assemblies.

“Array of parallel assemblies” two or more similar assemblies having similar characteristics connected in parallel.

“Series assembly” is two or more similar assemblies connected in series.

“Reactive impedance(s)” are inductors and/or capacitors.

“Opposite reactive impedance”, inductors and capacitors have opposite reactive impedances.

“Negative reactive impedance” is an impedance when expressed as a complex number, the imaginary part is less than zero.

“Positive reactive impedance” is an impedance when expressed as a complex number, the imaginary part is greater than zero.

“Negative reactive impedance frequency region” is a bandwidth of frequencies where every frequency in the bandwidth has an impedance when expressed as a complex number, the imaginary part is less than zero.

“Positive reactive impedance frequency region” is a bandwidth of frequencies where every frequency in the bandwidth has an impedance when expressed as a complex number, the imaginary part is greater than zero.

“Resonance or resonant frequency” is used herein as a generic term referring to resonance, self-resonance or series resonance depending on the context. Typically, they are all the same frequency for a given component or network.

“New resonant frequency” is a resonant frequency that does not exist as a resonant frequency in either component.

“New resonant circuit” is a network consisting of LCR impedances formed by an assembly that produces a new resonant frequency.

“Series resonance or series resonant frequency” is a LC series network where the center series connection between L and C is available and f equals the reciprocal of the square root of L times C. This is different from a series self-resonance where only the outside nodes of the element are available, for example, a capacitor, piezoelectric ceramic or Langevin transducer.

“Efficient electronic circuit” is a half bridge, full bridge, inverter or other circuit topology where the power devices switch between on and off for efficient operation.

“Oscillator circuit” is a generator that self oscillates at a resonant frequency of a network connected to its output.

“System” is an apparatus capable of producing sound waves typically consisting of an efficient electronic circuit driving a load containing a transducer array or an array of assemblies.

“Approximately square wave shaped waveform”, the voltage waveform produced by an efficient electronic circuit.

“Approximately sinusoidal shaped waveform” is a periodic voltage with curved edges formed from an approximately square wave shaped waveform by a LCR resonance.

“Reactive frequency region” is a range or bandwidth of frequencies within a component that has an impedance that is primarily inductive or capacitive,

“Series connection center node” is the node between the two components in an assembly.

“Outside nodes” are the open terminals of an assembly.

“Sweep bandwidth” is the size of the range of frequencies over which a transducer or assembly is driven.

“Center frequency” is a frequency approximately at the center of a sweep bandwidth.

f=frequency

fr, frn=fr, fr1, fr2, fr3, . . . =resonant frequencies

fa, fan=fa, fa1, fa2, fa3, . . . =anti-resonant frequencies

R=resistor

L=inductor

C=capacitor

Z=impedance

|Z|=magnitude of impedance

|Zx|=impedance where the magnitude of the capacitive impedance of one component equals the magnitude of the inductive impedance of the second component.

Zt=transmission line impedance

fx, fxn=fx, fx1, fx2, fx3, . . . =new resonant frequencies

fy, fyn=fy, fy1, fy2, fy3, . . . =additional new resonant frequencies

Ln=L1, L2, L3, L4, . . . =inductance as defined and calculated from the curve on a magnitude of impedance versus frequency plot.

Cn=C1, C2, C3, C4, . . . =capacitance as defined and calculated from the curve on a magnitude of impedance versus frequency plot.

In its most basic form, the invention consists of two different frequency components (each containing one or more piezoelectric ceramics) which are connected in series to form an assembly, that assembly having three nodes, the center node called the series connection center node and the two other nodes are called the outside nodes. Each component is designed to have one or more reactive frequency regions such that there exists one or more frequencies in said one or more reactive frequency regions where the magnitude of the reactive impedance of one component equals the magnitude of the opposite reactive impedance of the other component at a frequency in an overlapping capacitive and inductive region. This results in one or more new resonant frequencies (fx, fy) being formed in the assembly between the outside nodes of the assembly. Typically similar assemblies are connected in parallel.

Furthermore, one or more of these new resonant frequencies are powered by an efficient electronic circuit that supplies a drive voltage at a new resonant frequency or at a sweeping bandwidth of frequencies containing a new resonant frequency. The approximately square wave shaped waveform from the efficient electronic circuit is converted by the assembly into approximately sinusoidal shaped waveforms to each component, these approximately sinusoidal shaped waveforms having the proper phase for powering each component.

The above configuration (efficient electronic circuit directly driving an assembly or an array of parallel assemblies) for a system has the following advantages:

First, components (inductors, capacitors, relays, PCBs, etc.) between the efficient electronic circuit and the assembly are eliminated.

Second, the assembly converts the relatively low voltage approximately square wave shaped waveform generated by the efficient electronic circuit into two higher voltage approximately sinusoidal shaped waveforms with the correct phase for driving each component in the assembly.

Third, the efficient electronic circuit automatically supplies the correct power to any number of assemblies connected in parallel up to the maximum power capability of the efficient electronic circuit.

Forth, the two differently designed components self-compensate for temperature changes.

Fifth, half the components operate in the region between fr and fa where performance is typically superior.

Sixth, one embodiment of the invention maintains an inductive nature for the assembly that is the most efficient load for a bridge circuit.

Seventh, the RF cable transmits a relatively low voltage approximately square wave shaped waveform from the efficient electronic circuit to the assembly (rather than the high voltage sinusoid with current equipment), this results in less RF radiation.

Eight, for multiple frequency ultrasonic and megasonic systems, change the control frequency (a programming command) of the efficient electronic circuit to another of the multiple new resonant frequencies of a multiple frequency assembly and the frequency of the approximately square wave shaped waveform follows. The assembly automatically has formed a new resonance at the new frequency and converts the approximately square wave shaped waveform from the efficient electronic circuit into the new frequency sinusoids for properly driving the assembly at this second multiple frequency.

The following is a simplified step by step setup and experiment that allows a person skilled in the art to demonstrate the capability of an assembly built according to the invention to convert a low voltage square wave into two higher voltage approximately sinusoidal shaped waveforms with the correct phase for driving each component in the assembly with no added reactive impedances between the square wave and the assembly.

Select a first megasonic piezoelectric ceramic with a clean characteristic (monotonically increasing |Z| curve) between fr1 and fa1. For example, fr1=1.385 MHz and fa1=1.397 MHz. The subscript 1 refers to the first ceramic, not its overtone or harmonic. In most of the rest of this specification the subscript refers to the number of the overtone or harmonic.

Design and purchase a second similar size megasonic piezoelectric ceramic with fr2 equal to approximately the fa1 of the first megasonic piezoelectric ceramic. In the above example this second megasonic piezoelectric ceramic will have fr2 equal to approximately 1.397 MHz. Again, the subscript 2 refers to the second ceramic.

Place the two megasonic piezoelectric ceramics on aluminum foil with negative electrodes touching the foil. With a gain-phase analyzer (e.g., a HP 4194A) observe the Z vs. f curve between the two positive electrodes that are facing up. A new resonant frequency appears about halfway between fr1 and fa1 of the first megasonic piezoelectric ceramic. In the above example it will be at about 1.391 MHZ.

Connect a function generator between the two positive electrodes and set it to that new resonant frequency, i.e., 1.391 MHz. Output about a 5-volt square wave.

With an oscilloscope measure the voltage across the first megasonic piezoelectric ceramic, you will see a sinusoidal shaped waveform with a voltage higher than 5 volts. Similarly measure the voltage across the second megasonic piezoelectric ceramic, you will see another similar voltage sinusoid. If you consider the polarity of the sinusoids with respect to the polarity of the ceramics, you will see both ceramics are driven to expand at the same time and then both ceramics are driven to contract at the same time. This is what is needed to produce a strong megasonic wave.

Proper higher voltage sinusoidal shaped drive signals from a low voltage square wave requiring no inductors or capacitors, that is the essence of the invention.

The above example assumed megasonic rectangular PZT ceramics made with PZT-4 material and having a thickness of about 5 mm. These piezoelectric ceramics typically have resonant frequencies around 440 kHz, 1.4 MHZ, 2.3 MHZ, 3.2 MHz and 4.0 MHz. The above example used the resonances around 1.4 MHZ. Any of the four resonances could be used for the experiment, in fact, a multiple frequency demonstration using two or more of the resonances is possible.

The above experimental setup if built in a more rugged way, e.g., silver epoxied sterling silver connections to replace the aluminum foil conductor and silver epoxied wire leads to the positive electrodes with these wire leads driven by an efficient electronic circuit, can produce megasonic in liquids with a low cost system.

A specific embodiment of the above is a system consisting of an efficient electronic circuit coupled to an assembly consisting of two piezoelectric megasonic ceramics connected in series with a resonant frequency of the second approximately equal to the anti-resonant frequency of the first, whereas, a new resonant frequency is formed by the assembly and the efficient electronic circuit drives the assembly at this new resonant frequency.

Assemblies using megasonic piezoelectric ceramics can be made using naked megasonic piezoelectric ceramics as the components, or the megasonic piezoelectric ceramics can be bonded to a resonant plate or resonant tank. For single frequency systems, the resonant plate or tank should be optimized for the specific single frequency. For multiple frequency systems, the overall resonance is usually best if optimized for the highest frequency in the multiple frequency set.

In an analogous form, the invention consists of a first component being a first Langevin transducer, piezoelectric ceramic element or radial mode piezoelectric transducer, or a first array of two or more of these components in parallel with a positive reactive impedance frequency region(s) between a resonant frequency and an anti-resonant frequency of the first Langevin transducer, piezoelectric ceramic element, radial mode piezoelectric transducer or first array. The second component of the invention is a second Langevin transducer, piezoelectric ceramic element or radial mode piezoelectric transducer, or a second array of two or more of these components in parallel designed to have a negative reactive impedance frequency region(s) that overlaps part or all of the positive reactive impedance frequency region(s) of the first Langevin transducer, piezoelectric ceramic element, radial mode piezoelectric transducer or first array and which is further designed to have in this (these) overlapping frequency region(s) at least one frequency where the magnitude of the negative reactive impedance of this second Langevin transducer, piezoelectric ceramic element, radial mode piezoelectric transducer or second array equals the magnitude of the positive reactive impedance of the first Langevin transducer, piezoelectric ceramic element, radial mode piezoelectric transducer or first array. Whereas the first component is connected in series with the second component forming an assembly containing new resonant circuit(s) at a resonant frequency (fx or fx1, fx2, fx3, . . . or fx1, fx3, fx5, . . . ) where the positive reactive impedance characteristic of the first component crosses the negative reactive impedance characteristic of the second component on a graph of magnitude of impedance (|Z|) versus frequency (f) causing the series connection of the two components to self-resonant at fx or fx1, fx2, fx3, . . . or fx1, fx3, fx5, . . . which are new resonant frequencies located between the resonant frequency and an anti-resonant frequency of the first component.

The assembly has three nodes, the center node called the series connection center node, and the two other nodes are called the outside nodes.

The series connection center nodes within each assembly can be connected to ground, or they can be isolated and float independently of each other, or the floating series connection center nodes can be connected together without grounding this network. Also, the assemblies can be driven independently, or two or more assemblies can be connected in parallel to form an array of parallel assemblies.

It is also possible to connect the assemblies in series, but this is not a preferred configuration because one of those assemblies would have to be built with an opposite polarity to get the proper phase to the approximately sinusoidal shaped waveforms.

The invention further includes assemblies consisting of series connected piezoelectric ceramic elements where a first piezoelectric ceramic element has two or more inductive frequency regions typically located at about odd integer multiples (1, 3, 5, . . . ) of the fundamental resonant frequency (fr1) and fundamental anti-resonant frequency (fa) of the first piezoelectric ceramic element, these inductive regions spanning a frequency range between a resonant frequency and an anti-resonant frequency of the first piezoelectric ceramic element, for example, one inductive region can be from fr1 to fa1, a second inductive region can be from fr3 to fa3, a third inductive region can be from fr5 to fa5. A second piezoelectric ceramic element designed to have two of more capacitive frequency regions that overlap part or all of the inductive frequency regions of the first piezoelectric ceramic element and further designed to have in each of these overlapping frequency regions at least one frequency where the magnitude of the inductive impedance of the first piezoelectric ceramic element is equal to the magnitude of the capacitance impedance of the second piezoelectric ceramic element. Whereas the first piezoelectric ceramic element is connected in series with the second piezoelectric ceramic element forming new resonant circuits at the frequencies (fx1, fx3, fx5, . . . ) where the inductive characteristics of the first piezoelectric ceramic element crosses the capacitive characteristics of the second piezoelectric ceramic element on a graph of magnitude of impedance (|Z|) versus frequency (f) allowing the assembly to self-resonant at fx1, fx3, fx5, . . . which are new resonant frequencies between each resonant frequency and an anti-resonant frequency pair (fr1 to fa1, fr3 to fa3, fr5 to fa5, . . . ). The above references are for the preferred embodiment where fr2=fa1. More generally, the fx1, fx3, fx5, . . . are new resonant frequencies between each resonant frequency pair (fr1 to fr2, fr3 to fr4, fr5 to fr6, . . . ).

The invention also includes series connected Langevin transducers where a first Langevin transducer has two or more inductive frequency regions typically located at about integer multiples (1, 2, 3, . . . ) of the fundamental resonant frequency (fr1) and fundamental anti-resonant frequency (fa1) of the first Langevin transducer, these inductive regions spanning a frequency range between a resonant frequency and an anti-resonant frequency pair of the first Langevin transducer, for example, one inductive region can be from fr1 to fa1, a second inductive region can be from fr2 to fa2, a third inductive region can be from fr3 to fa3. A second Langevin transducer is designed to have two of more capacitive frequency regions that overlap part or all of the inductive frequency regions of the first Langevin transducer and is further designed to have in each of these overlapping frequency regions at least one frequency where the magnitude of the inductive impedance of the first Langevin transducer is equal to the magnitude of the capacitive impedance of the second Langevin transducer. The first Langevin transducer is connected in series with the second Langevin transducer forming resonant circuits at the frequencies (fx1, fx2, fx3, . . . ) where the inductive characteristics of the first piezoelectric ceramic element crosses the capacitive characteristics of the second piezoelectric ceramic element on a graph of magnitude of impedance (|Z|) versus frequency (f) allowing the assembly to self-resonant at fx1, fx2, fx3, . . . which are new resonant frequencies between each resonant frequency and an anti-resonant frequency pair (fr1 to fa1, fr2 to fa2, fr3 to fa3, . . . ). The above references are for the preferred embodiment where fr2=fa1. More generally, the fx1, fx2, fx3, . . . are new resonant frequencies between each resonant frequency pair (fr1 to fr2, fr3 to fr4, fr5 to fr6, . . . ).

In a preferred embodiment, the first Langevin transducer, piezoelectric ceramic element or radial mode piezoelectric transducer has a resonant frequency (fr1) and an anti-resonant frequency (fa1) and the second Langevin transducer, piezoelectric ceramic element or radial mode piezoelectric transducer is designed to have a resonant frequency (fr2) equal to the anti-resonant frequency (fa1) of the first Langevin transducer, piezoelectric ceramic element or radial mode piezoelectric transducer. The first and second Langevin transducers, piezoelectric ceramic elements or radial mode piezoelectric transducers are connected in series forming an assembly. A new resonant frequency (fx) approximately halfway between the resonant frequency and anti-resonant frequency of the first Langevin transducer, piezoelectric ceramic element or radial mode piezoelectric transducer is formed. This new resonant frequency is an optimum drive center frequency for the assembly.

The above preferred embodiment uses the capacitive characteristics located below the resonant frequency of the second component. A second preferred embodiment uses the capacitive characteristics located above the anti-resonant frequency of the first component as detailed below.

In this second preferred embodiment, the second Langevin transducer, piezoelectric ceramic element or radial mode piezoelectric transducer has a resonant frequency (fr2) and the first Langevin transducer, piezoelectric ceramic element or radial mode piezoelectric transducer is designed to have a anti-resonant frequency (fa1) equal to the resonant frequency (fr2) of the second Langevin transducer, piezoelectric ceramic element or radial mode piezoelectric transducer. The first and second Langevin transducers, piezoelectric ceramic elements or radial mode piezoelectric transducers are connected in series forming an assembly. A new resonance (fy) approximately halfway between the resonant frequency (fr2) and anti-resonant frequency (fa2) of the second Langevin transducer, piezoelectric ceramic element or radial mode piezoelectric transducer is formed. This new resonant frequency fy is an optimum drive center frequency for the assembly.

In each assembly there typically are formed both new resonances, fx and fy.

Also included in the invention is an efficient electronic circuit programmed to drive the first new resonant frequency fx and alternately drive the second new resonant frequency fy for improved multiple frequency effects.

Also included in one embodiment are reactive impedances connected in parallel and/or series to one or more components in an assembly.

Also included in one embodiment are assemblies wherein the first component and/or second component in an assembly consists of an array of two or more first components or an array of two or more second components connected in parallel.

Also included in one embodiment are assemblies wherein the first component and/or second component in an assembly consists of two first components and/or two second components connected in series.

Also included in one embodiment are assemblies wherein the new resonant frequency fx is formed near the resonant frequency fr1 of the first component resulting in a relatively long inductive frequency region above fx. This inductive region is an efficient load for bridge circuits.

Also included in one embodiment are assemblies wherein the first component and/or second component in an assembly consists of an array of two or more first components or an array of two or more second components connected in parallel.

These assemblies, parallel or series combinations of assemblies, are driven by the switched output (typically simulating a square wave) of a bridge circuit or similar high/low switching electronic circuit (herein referred to as an “efficient electronic circuit”) at a frequency or bandwidth of frequencies containing the new resonance(s) formed by the assembly. The new resonance(s) formed by the assembly converts the approximately square wave shaped waveform from the efficient electronic circuit into proper approximately sinusoidal shaped waveforms for each component in the assembly.

Also included in one embodiment are Langevin transducers where the bias bolt pressure or torque is adjusted to produce a desired inductive or capacitive frequency region characteristic.

In the most practical implementation of the invention, an efficient electronic circuit, e.g., a bridge electronic circuit, is used to power an assembly at fx or sweeping in a frequency bandwidth containing fx. The approximately square wave shaped waveform from the efficient electronic circuit becomes two approximately sinusoidal shaped waveforms across each component at fx. The two approximately sinusoidal shaped waveforms have the correct phase for driving each component in the assembly to expand together and then contract together.

Typically, two or more similar assemblies are connected in parallel. The efficient electronic circuit automatically supplies the correct power to each assembly up to the maximum power capability of the efficient electronic circuit.

Also included in one embodiment is an efficient electronic circuit with its approximately square wave shaped waveform output connected to one end of a transmission line with impedance Zt, the other end of the transmission line is connected to the primary of an impedance matching transformer that transforms Zt to Zx, the resistive impedance of a new resonance. The secondary of the impedance matching transformer is connected to the assembly or array of parallel assemblies having the new resonance with impedance Zx. This embodiment is especially useful for higher megasonic frequencies and/or long distances between the efficient electronic circuit and the assembly or array of parallel assemblies.

A specific example of a ten mode megasonic system designed according to embodiments of this invention with sufficient details such that is can be reproduced by a person skilled in the art is: An efficient electronic circuit consisting of a SiC (silicon carbide MOSFETs) bridge circuit capable of producing a single frequency at about 440 kHz, 1.4 MHZ, 2.3 MHz, 3.2 MHZ and 4.0 MHz and sweeping frequencies in a bandwidth around each center frequency 440 kHz, 1.4 MHZ, 2.3 MH2, 3.2 MHz and 4.0 MHz. A 316L stainless steel plate about 0.242 inches thick resonating at about 4.0 MHz and containing nine half wavelengths of 4.0 MHz sound waves has four similar rectangular PZT-4 ceramics bonded to this plate each with a thickness of about 5 mm. A second set of four rectangular PZT-4 ceramics are designed and procured having a specific resonant frequency (when bonded to the 0.242 inch plate) in the region around 4.0 MHZ about equal to the anti-resonant frequency of the first four bonded PZT-4 ceramics in the region around 4.0 MHz. The positive electrodes of the eight PZT-4 ceramics face in the same direction, upward away from the plate. The negative electrodes are connected together by the conductivity of the plate and bonding epoxy. The positive electrodes of the first group are connected together and form a first node. The positive electrodes of the second group are connected together and form a second node. The efficient electronic circuit is coupled to these nodes. The efficient electronic circuit is programmed to output any selected single frequency 440 kHz, 1.4 MHZ, 2.3 MHz, 3.2 MHz or 4.0 MHz and any sweeping frequency around the center frequencies 440 kHz, 1.4 MHZ, 2.3 MH2, 3.2 MHz and 4.0 MHz. This gives ten modes of operation. Typically a PLL (phase lock loop) is used to lock onto the specific new resonant frequencies.

Also included in one embodiment, a first component containing one or more piezoelectric ceramics designed to have a resonant frequency (fr) and an anti-resonant frequency (fa) with an inductive frequency region (L) between fr and fa. A second component containing one or more piezoelectric ceramics designed to have a capacitive frequency region (C) that overlaps part or all of L and which is further designed to have in said overlapping frequency region at least one frequency (fx and/or fy) where the magnitude of the capacitive impedance of said second component (|Zx|) equals the magnitude of the inductive impedance (|Zx|) of said first component; whereas the first component is connected in series with the second component forming an assembly containing at least one new resonant circuit at said fx or fy.

Also included in one embodiment, a first component containing one or more piezoelectric ceramics designed to have a resonant frequency and an anti-resonant frequency with an inductive frequency region between said resonant frequency and said anti-resonant frequency. A second component containing one or more piezoelectric ceramics designed to have a capacitive frequency region that overlaps part or all of said inductive frequency region and which is further designed to have in said overlapping frequency region a frequency where the magnitude of the capacitive impedance of said second component equals the magnitude of the inductive impedance of said first component; whereas the first component is connected in series with the second component forming an assembly containing a new resonant circuit at said frequency where the magnitude of the capacitive impedance of said second component equals the magnitude of the inductive impedance of said first component. This at least one new resonant frequency(s) at said frequency(s) where the magnitude of the capacitive impedance of said second component equals the magnitude of the inductive impedance of said first component.

Also included in one embodiment, a first component consisting of a first Langevin transducer, piezoelectric ceramic element or radial mode piezoelectric transducer, or a first array of two or more of these components in parallel with a single or multiple inductive frequency regions between a resonant frequency and an anti-resonant frequency of the first Langevin transducer, piezoelectric ceramic element, radial mode piezoelectric transducer or first array and for multiple inductive frequency regions they are typically located at about integer multiples or odd integer multiples of this first Langevin transducer, piezoelectric ceramic element, radial mode piezoelectric transducer or first array's fundamental resonant frequency and fundamental anti-resonant frequency; a second component consisting of a second Langevin transducer, piezoelectric ceramic element or radial mode piezoelectric transducer, or a second array of two or more of these components in parallel designed to have capacitive frequency regions that overlap part or all of the inductive frequency regions of the first Langevin transducer, piezoelectric ceramic element, radial mode piezoelectric transducer or first array and which is further designed to have in one or more of these overlapping frequency regions at least one frequency where the magnitude of the capacitive impedance of this second Langevin transducer, piezoelectric ceramic element, radial mode piezoelectric transducer or second array equals the magnitude of the inductive impedance of the first Langevin transducer, piezoelectric ceramic element, radial mode piezoelectric transducer or first array; whereas the first Langevin transducer, piezoelectric ceramic element, radial mode piezoelectric transducer or first array is connected in series with the second Langevin transducer, piezoelectric ceramic element, radial mode piezoelectric transducer or second array forming an assembly containing a new resonant circuit(s) at the new resonant frequencies (fx or fx1, fx2, . . . or fx1, fx3, . . . ) where the inductive characteristic of the first Langevin transducer, piezoelectric ceramic element, radial mode piezoelectric transducer or first array crosses the capacitive characteristic of the second Langevin transducer, piezoelectric ceramic element, radial mode piezoelectric transducer or second array on a graph of magnitude of impedance (|Z|) versus frequency (f) causing the series connection of the two components or arrays to self-resonant at fx1 or fx1, fx2, fx3, . . . , or fx1, fx3, fx5, . . . , which are new resonant frequencies between a resonant frequency and an anti-resonant frequency of the first Langevin transducer, piezoelectric ceramic element, radial mode piezoelectric transducer or first array.

An assembly wherein the assembly is driven by an efficient electronic circuit capable of producing the new resonant frequencies (fx or fx1, fx2, . . . or fx1, fx3, . . . ) wherein multiple frequency operation of the assembly is accomplished.

Also included in one embodiment, a first piezoelectric ceramic element with an inductive frequency region between a resonant frequency and an anti-resonant frequency of the first piezoelectric ceramic element; a second piezoelectric ceramic element designed to have a capacitive frequency region that overlaps part or all of the inductive frequency region of the first piezoelectric ceramic element and is further designed to have in this overlapping frequency region at least one frequency where the magnitude of the inductive impedance of the first piezoelectric ceramic element is equal to the magnitude of the capacitance impedance of the second piezoelectric ceramic element; whereas the first piezoelectric ceramic element is connected in series with the second piezoelectric ceramic element forming an assembly containing a new resonant circuit which resonates at the new resonant frequency (fx) where the inductive characteristic of the first piezoelectric ceramic element crosses the capacitive characteristic of the second piezoelectric ceramic element on a graph of magnitude of impedance (|Z|) versus frequency (f) allowing the assembly to self-resonant at fx which is a frequency between the resonant frequency and anti-resonant frequency of the first piezoelectric ceramic element.

An assembly wherein two or more assemblies are connected in parallel forming an array of paralleled assemblies.

An array of paralleled assemblies wherein the array is driven by an efficient electronic circuit at the new resonant frequency (or in a sweeping frequency bandwidth containing the new resonant frequency) formed by the array of paralleled assemblies resulting in approximately sinusoidal drive signals to the components of the assemblies, wherein said efficient electronic circuit automatically outputs the same power to each assembly resulting in the array of paralleled assemblies receiving the correct drive power for any number of assemblies up to the rated output power of the efficient electronic circuit.

Also included in one embodiment, two different frequency components each containing one or more piezoelectric ceramics are connected in series to form an assembly, that assembly having three nodes, the center node called the series connection center node and the two other nodes are called the outside nodes, whereas each component is designed to have one or more reactive frequency regions such that there exists one or more frequencies in said one or more reactive frequency regions where the magnitude of the reactive impedance of one component equals the magnitude of the opposite reactive impedance of the other component. Whereas one or more new resonant frequencies are formed in the assembly between the outside nodes of the assembly. Whereas one or more of these new resonant frequencies are powered by an efficient electronic circuit that supplies a drive voltage at a new resonant frequency or at a sweeping bandwidth of frequencies containing a new resonant frequency. Whereas the approximately square wave shaped waveform from the efficient electronic circuit is converted by the assembly into approximately sinusoidal shaped waveforms to each component, these approximately sinusoidal shaped waveforms having the proper phase for powering each component.

An assembly wherein the series connection center node within the assembly is connected to ground.

An assembly wherein two or more assemblies are connected in parallel forming an array of paralleled assemblies.

Assemblies wherein the series connection center nodes within the assemblies are connected to ground.

Assemblies wherein the series connection center nodes within the assemblies are isolated and float independently of each other.

Assemblies wherein the series connection center nodes within the assemblies are connected together.

An assembly wherein two or more assemblies are connected in series forming series assemblies.

A series assembly wherein two or more of the series assemblies are connected in parallel and an assembly wherein reactive impedance(s) is connected in parallel and/or series to one or more components in the assembly.

An assembly wherein the array of paralleled assemblies is driven by an efficient electronic circuit at the new resonant frequency (or in a sweeping frequency bandwidth containing the new resonant frequency) formed by the assembly resulting in approximately sinusoidal shaped waveforms to the components of the assembly.

An assembly wherein the first component and/or second component in an assembly consists of an array of two or more first components and/or an array of two or more second components connected in parallel.

Also included in one embodiment, an array of paralleled assemblies wherein the array is driven by an efficient electronic circuit at a new resonant frequency (or in a sweeping frequency bandwidth containing a new resonant frequency) formed by the array of paralleled assemblies resulting in approximately sinusoidal shaped waveforms to the components of the assemblies wherein the efficient electronic circuit automatically outputs the same power to each assembly resulting in the array of paralleled assemblies receiving the correct drive power for any number of assemblies up to the rated output power of the efficient electronic circuit.

An assembly wherein one component in an assembly with a reactive impedance region also has an opposite reactive impedance region that overlaps part or all of the reactive impedance region of the other component forming a second new resonant frequency (fy).

Also included in one embodiment, the assembly wherein an efficient electronic circuit is programmed to drive the first new resonant frequency fx and alternately drive the second new resonant frequency fy.

Also included in one embodiment is an assembly wherein one component also contains one or more additional inductive frequency regions, and the other component contains one or more additional capacitive frequency regions that overlap part or all of one or more of the additional inductive frequency regions of the first component forming additional new resonant frequencies.

Also included in one embodiment, a first component consisting of a first Langevin transducer, piezoelectric ceramic element or radial mode piezoelectric transducer, or a first array of two or more of these components in parallel with a single or multiple inductive frequency regions between a resonant frequency and an anti-resonant frequency of the first Langevin transducer, piezoelectric ceramic element, radial mode piezoelectric transducer or first array and for multiple inductive frequency regions they are typically located at about integer multiples or odd integer multiples of this first Langevin transducer, piezoelectric ceramic element, radial mode piezoelectric transducer or first array's fundamental resonant frequency and fundamental anti-resonant frequency; a second component consisting of a second Langevin transducer, piezoelectric ceramic element or radial mode piezoelectric transducer, or a second array of two or more of these components in parallel designed to have capacitive frequency regions that overlap part or all of the inductive frequency regions of the first Langevin transducer, piezoelectric ceramic element, radial mode piezoelectric transducer or first array and which is further designed to have in one or more of these overlapping frequency regions at least one frequency where the magnitude of the capacitive impedance of this second Langevin transducer, piezoelectric ceramic element, radial mode piezoelectric transducer or second array equals the magnitude of the inductive impedance of the first Langevin transducer, piezoelectric ceramic element, radial mode piezoelectric transducer or first array; whereas the first Langevin transducer, piezoelectric ceramic element, radial mode piezoelectric transducer or first array is connected in series with the second Langevin transducer, piezoelectric ceramic element, radial mode piezoelectric transducer or second array forming an assembly containing a new resonant circuit(s) at the new resonant frequencies (fx or fx1, fx2, . . . or fx1, fx3, . . . ) where the inductive characteristic of the first Langevin transducer, piezoelectric ceramic element, radial mode piezoelectric transducer or first array crosses the capacitive characteristic of the second Langevin transducer, piezoelectric ceramic element, radial mode piezoelectric transducer or second array on a graph of magnitude of impedance (|Z|) versus frequency (f) causing the series connection of the two components or arrays to self-resonant at fx1 or fx1, fx2, fx3, . . . , or fx1, fx3, fx5, . . . , which are new resonant frequencies between a resonant frequency and an anti-resonant frequency of the first Langevin transducer, piezoelectric ceramic element, radial mode piezoelectric transducer or first array.

An assembly as described above wherein the assembly is driven by an efficient electronic circuit capable of producing the new resonant frequencies (fx or fx1, fx2, . . . or fx1, fx3, . . . ) wherein multiple frequency operation of the assembly is accomplished.

Also included in one embodiment, a first piezoelectric ceramic element with an inductive frequency region between a resonant frequency and an anti-resonant frequency of the first piezoelectric ceramic element; a second piezoelectric ceramic element designed to have a capacitive frequency region that overlaps part or all of the inductive frequency region of the first piezoelectric ceramic element and is further designed to have in this overlapping frequency region at least one frequency where the magnitude of the inductive impedance of the first piezoelectric ceramic element is equal to the magnitude of the capacitance impedance of the second piezoelectric ceramic element; whereas the first piezoelectric ceramic element is connected in series with the second piezoelectric ceramic element forming an assembly containing a new resonant circuit which resonates at the new resonant frequency (fx) where the inductive characteristic of the first piezoelectric ceramic element crosses the capacitive characteristic of the second piezoelectric ceramic element on a graph of magnitude of impedance (|Z|) versus frequency (f) allowing the assembly to self-resonant at fx which is a frequency between the resonant frequencies of the first and second piezoelectric ceramic elements.

The above assembly wherein two or more assemblies are connected in parallel forming an array of paralleled assemblies.

Also included in one embodiment is an array of paralleled assemblies described above wherein the array is driven by an efficient electronic circuit at the new resonant frequency (or in a sweeping frequency bandwidth containing the new resonant frequency) formed by the array of paralleled assemblies resulting in approximately sinusoidal drive signals to the components of the assemblies, wherein said efficient electronic circuit automatically outputs the same power to each assembly resulting in the array of paralleled assemblies receiving the correct drive power for any number of assemblies up to the rated output power of the efficient electronic circuit.

Also included in one embodiment is a first component designed to have a resonant frequency (fr11) and a higher anti-resonant frequency (fa11), wherein said first component exhibits a negative reactive impedance frequency range below fr11 (referred to as frequency range −Z11), a positive reactive impedance frequency range between fr11 and fa11 (referred to as frequency range+Z11), and a negative reactive impedance frequency range above fa11 (referred to as frequency range −Z12). A second component designed to have a resonant frequency (fr21) greater than fr11, a higher anti-resonant frequency (fa21), a negative reactive impedance frequency range below fr21 (referred to as frequency range −Z21), a positive reactive impedance frequency range between fr21 and fa21 (referred to as frequency range+Z21), and a negative reactive impedance frequency range above fa21 (referred to as frequency range −Z22), wherein the design of the second component further requires some or all of frequency range −Z21 overlaps some or all of frequency range+Z11 (referred to as overlapping frequency range delta fo1), and some or all of frequency range+Z21 overlaps some or all of frequency range −Z12 (referred to as overlapping frequency range delta fo2). In said overlapping frequency range delta fo1, the design of the second component is such as to produce a frequency (fx) where the magnitude of the negative reactive impedance at fx of said second component equals the magnitude of the positive reactive impedance of said first component at fx. In said overlapping frequency range delta fo2, the design of the second component is such as to produce a frequency (fy) where the magnitude of the positive reactive impedance at fy of said second component equals the magnitude of the negative reactive impedance of said first component at fy. The first component is connected in series with the second component forming an assembly (Assembly G) having three nodes, the center node called the series connection center node and the two other nodes are called the outside nodes, whereas between the two outside nodes are produced a first new resonant frequency at fx and a second new resonant frequency at fy where fx and fy are also series resonant frequencies and where fx is greater than fr11 and fy is greater than fr21.

Also included in one embodiment is Assembly G further comprising an efficient electronic circuit coupled or connected to the outside nodes of the assembly, wherein the efficient electronic circuit is designed or programmed to drive the assembly at the first new resonant frequency fx, the second new resonant frequency fy, or to alternately drive the assembly at the first new resonant frequency fx and at the second new resonant frequency fy.

Also included in one embodiment is Assembly G, further comprising an efficient electronic circuit coupled or connected to the outside nodes of the assembly, wherein the efficient electronic circuit is designed or programmed to drive the assembly through one or more sweeping frequency bandwidths each containing one or more new resonant frequencies (fx and/or fy).

Also included in one embodiment is Assembly G wherein the first component also contains one or more additional harmonic or overtone frequency regions, and the second component is designed to also satisfy the Assembly G characteristics in this one or more harmonic or overtone frequency regions forming additional new resonant frequencies.

Also included in one embodiment is the harmonic or overtone version of Assembly G, further comprising an efficient electronic circuit coupled or connected to the outside nodes of the assembly, wherein the efficient electronic circuit is designed or programmed to drive the assembly at any one or more of the new resonant frequencies.

Also included in one embodiment is the harmonic or overtone version of Assembly G, further comprising an efficient electronic circuit coupled or connected to the outside nodes of the assembly, wherein the efficient electronic circuit is designed or programmed to drive the assembly through one or more sweeping frequency bandwidths each containing one or more new resonant frequencies.

Also included in one embodiment is Assembly G, further comprising an oscillator circuit coupled or connected to the outside nodes of the assembly, wherein the oscillator circuit is designed to drive the assembly at the first new resonant frequency fx, the second new resonant frequency fy, or to alternately drive the assembly at the first new resonant frequency fx and at the second new resonant frequency fy.

Also included in one embodiment is Assembly G, further comprising an oscillator circuit coupled or connected to the outside nodes of the assembly, wherein the oscillator circuit is designed to drive the assembly at one or more of the new resonant frequencies or sweeping around one or more of the new resonant frequencies.

Also included in one embodiment is Assembly G, further comprising an efficient electronic circuit with its approximately square wave shaped waveform output connected to one end of a transmission line with impedance Zt, the other end of the transmission line is connected to the primary of an impedance matching transformer that transforms Zt to Zx, the resistive impedance of a new resonance. The secondary of the impedance matching transformer is connected to the assembly or array of parallel assemblies having the new resonance with impedance Zx.

Also included in one embodiment is an Assembly H comprising: A first component consisting of an array of paralleled Langevin transducers for frequencies up to 350 kHz or an array of paralleled piezoelectric ceramics for megasonic frequencies connected in parallel with a capacitor. A second component consisting of an array of paralleled Langevin transducers for frequencies up to 350 kHz or an array of paralleled piezoelectric ceramics for megasonic frequencies connected in parallel with an inductor. The first component is connected in series with the second component forming an assembly having three nodes, the center node called the series connection center node and the two other nodes are called the outside nodes, whereas between the two outside nodes is produced a series resonant frequency.

Also included in one embodiment is Assembly H further comprising an efficient electronic circuit coupled or connected to the outside nodes of the assembly, wherein the efficient electronic circuit is designed or programmed to drive the assembly at the series resonant frequency.

Also included in one embodiment is Assembly H further comprising an efficient electronic circuit coupled or connected to the outside nodes of the assembly, wherein the efficient electronic circuit is designed or programmed to drive the assembly sweeping through a bandwidth of frequencies containing the series resonant frequency.

Also included in one embodiment is Assembly H, wherein the series connection center node is floating, connected to ground, or interconnected with each other series connection center nodes.

Also included in one embodiment is Assembly H further comprising an oscillator circuit coupled or connected to the outside nodes of the assembly, wherein the oscillator circuit is designed to drive the assembly at the series resonant frequency or sweeping around the series resonant frequency.

Also included in one embodiment is Assembly H where said parallel capacitor and said parallel inductor are remotely located.

Also included in one embodiment is Assembly J consisting of wo different frequency components each containing one or more piezoelectric ceramics are connected in series to form an assembly, that assembly having three nodes, the center node called the series connection center node and the two other nodes are called the outside nodes, whereas each component is designed to have one or more reactive frequency regions such that there exists one or more frequencies in said one or more reactive frequency regions where the magnitude of the reactive impedance of one component equals the magnitude of the opposite reactive impedance of the other component at a frequency in an overlapping negative reactive impedance frequency region and positive reactive impedance frequency region. Whereas one or more new resonant frequencies which are also series resonant frequencies are formed in the assembly between the outside nodes of the assembly. Whereas one or more of these new resonant frequencies are driven by an efficient electronic circuit that supplies a drive voltage at a new resonant frequency or at a sweeping bandwidth of frequencies containing a new resonant frequency. Whereas the approximately square wave shaped waveform from the efficient electronic circuit is converted by the assembly into approximately sinusoidal shaped waveforms to each component, these approximately sinusoidal shaped waveforms having the proper phase for driving each component to produce ultrasound.

### BRIEF DESCRIPTION OF THE DRAWINGS

FIG. 1 is a block diagram of a modern day ultrasonic and megasonic system.

FIG. 2 is a block diagram of a single assembly embodiment driven by an efficient electronic circuit.

FIG. 3 shows typical frequency verses magnitude of impedance curves for two components of an assembly.

FIG. 4 is a schematic diagram of multiple assemblies connected in parallel with their series connection center nodes grounded.

FIG. 5 is two schematic diagrams of assemblies showing the efficient electronic circuit automatically supplying the correct power to each assembly.

FIG. 6 is a schematic diagram of an assembly with a reactive impedance connected in parallel with one of the components in the assembly.

FIG. 7 is a schematic diagram of an assembly where a component is replaced by an array of components.

FIG. 8 is a schematic diagram of assemblies connected in series.

FIG. 9 shows typical frequency verses magnitude of impedance curves for two components of a multiple frequency assembly.

FIG. 10 shows typical frequency verses magnitude of impedance curves for two components with characteristics best for being driven by bridge circuits.

FIG. 11 shows typical frequency verses log magnitude of impedance curves for two components with characteristics of Assembly G.

FIG. 12 shows a self oscillator circuit driving an inventive assembly.

FIG. 13 shows a typical diagram for Assembly H.

FIG. 14 shows a typical diagram for Assembly J.

### DETAILED DESCRIPTION OF THE EMBODIMENTS

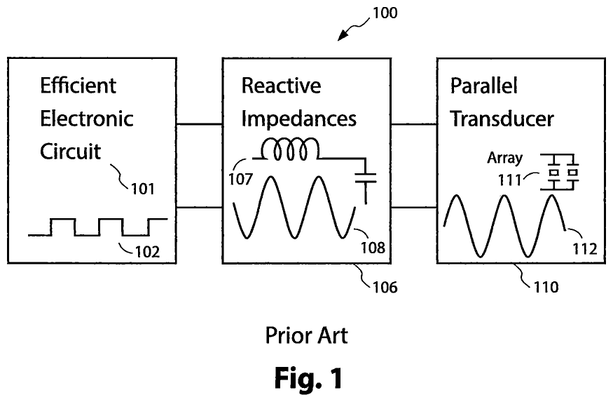

FIG. 1 block diagram 100 represents a typical modern day ultrasonic or megasonic generator 101 consisting of a circuit topology where the power devices switch from on to off 102 for efficient operation. This switching results in an approximately square wave shaped waveform 102 at the output of the efficient electronic circuit 101. Bridge circuits, both half bridge and full bridge, as are well known in the art are the most commonly used topologies for this application. Reactive impedances 107 in the second block 106 resonate with the parallel transducer array 111 in the third block 110. This results in approximately sinusoidal shaped waveforms 108 and 112.

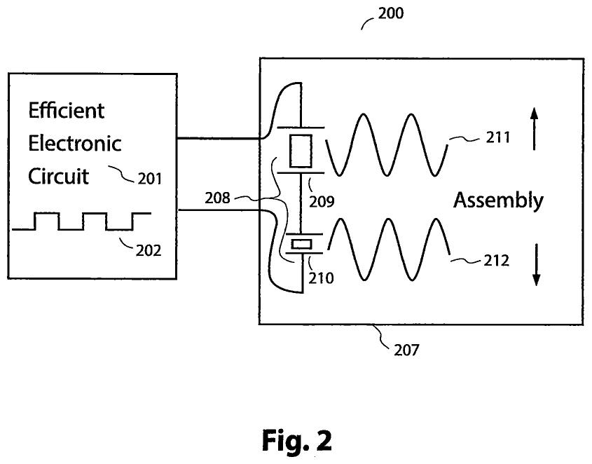

FIG. 2 block diagram 200 represents an embodiment consisting of a circuit topology where the power devices switch from on to off 202 for efficient operation. This switching results in an approximately square wave shaped waveform 202 at the output of the efficient electronic circuit 201. The second block 207 is an assembly 208 consisting of two components 209 and 210 having different impedance characteristics according to an embodiment, e.g., fa1=fr2. The assembly forms a new resonance between fr1 and fr2 according to an embodiment. The efficient electronic circuit 201 is set to produce square wave 202 at the new resonant frequency. This results in approximately sinusoidal shaped waveforms 211 and 212 across each component 209 and 210 respectively.

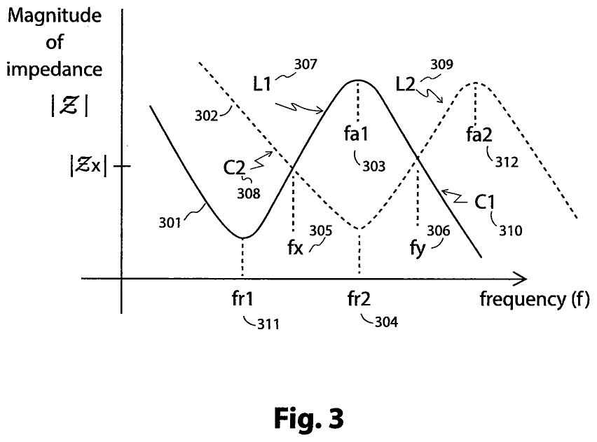

FIG. 3 is magnitude of impedance versus frequency graphs 301 and 302 of two components in an assembly according to preferred embodiments. Anti-resonant frequency fa1 303 of graph 301 is designed to be approximately equal to resonant frequency fr2 304 of graph 302. This results in two new resonant frequencies fx 305 and fy 306 where L1 307 resonates with C2 308 at fx 305 and where L2 309 resonates with C1 310 at fy 306. New resonant frequency fx 305 is located approximately half way between resonant frequency fr1 311 and anti-resonant frequency fa1 303 of graph 301. New resonant frequency fy 306 is located approximately half way between resonant frequency fr2 304 and anti-resonant frequency fa2 312 of graph 302. When driven by a periodic waveform (e.g., a square wave) at fx 305 or fy 306, approximately sinusoidal shaped waveforms are formed at fx 305 and fy 306 by the assembly.

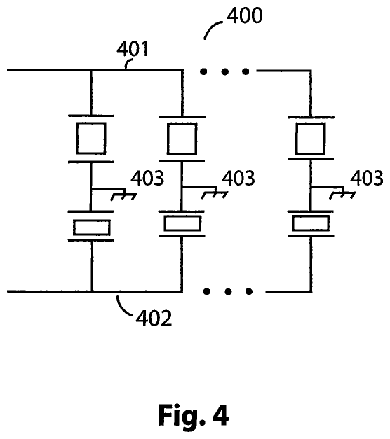

FIG. 4 shows a schematic of parallel assemblies 400 with outside nodes 401 and 402 and series connection center nodes 403. In this embodiment the series connection center nodes are grounded 403.

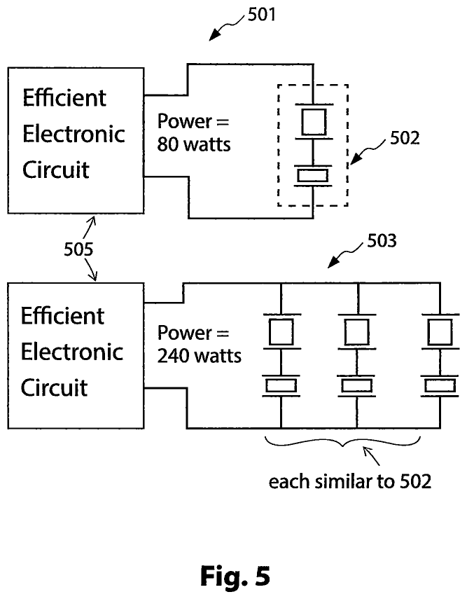

FIG. 5 shows schematics of two systems, the first 501 containing one assembly 502 and the second 503 containing three assemblies each similar to assembly 502. Efficient electronic circuit 505 is identical in each system 501 and 503. The first system 501 is powered by 80 watts and the second system 503 automatically is powered by three times the power of the first system 501, i.e., 240 watts.

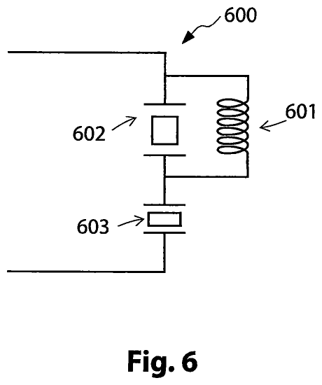

FIG. 6 shows a schematic of an assembly 600 with reactive impedance 601 connected in parallel with one component 602 of the assembly (an inductor is shown as the reactive impedance). This is most useful for sweeping frequency applications because it improves the sweep frequency bandwidth when the inductor 601 is in parallel with the lower frequency component 602 causing its anti-resonant frequency fa1 to increase. Then when the higher frequency component 603 is designed so its resonant frequency fr2 is approximately equal to this higher anti-resonant frequency fa1 of the lower frequency component 602, the bandwidth between the resonant frequencies fr1 to fr2 of the two components 602 and 603 is larger.

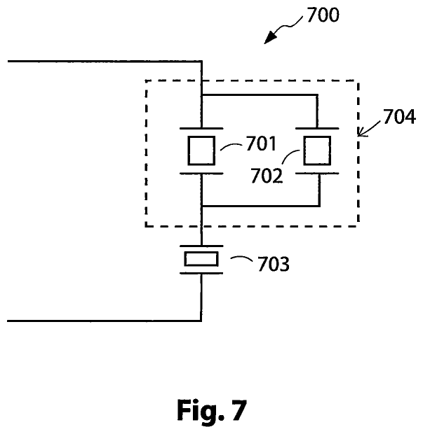

FIG. 7 shows a schematic of an assembly 700 where one component 704 consists of an array of similar parallel components 701 and 702. Series component 703 completes the assembly 700.

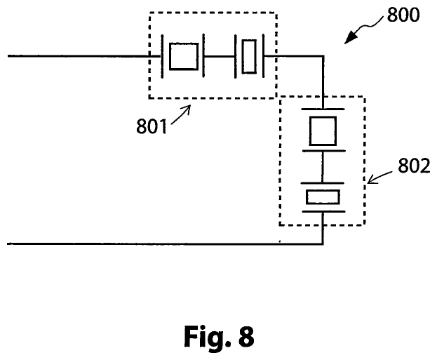

FIG. 8 shows a schematic of series assemblies 800 consisting of two similar assemblies 801 and 802 connected in series.

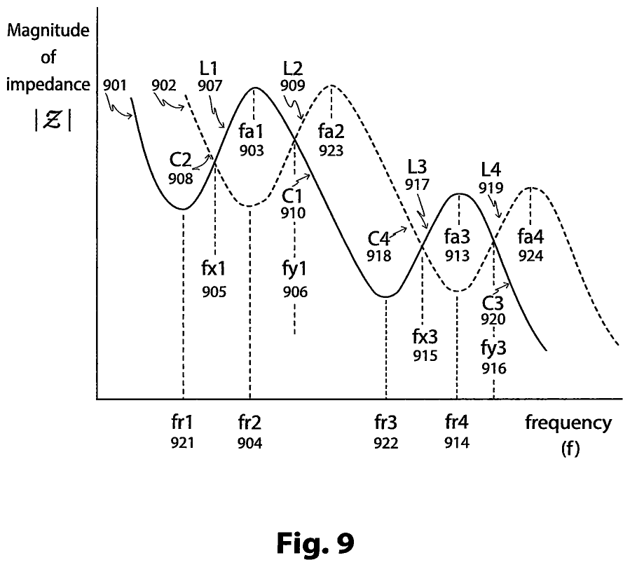

FIG. 9 is magnitude of impedance |Z| versus frequency f graphs 901 and 902 of two components in an assembly according to a multiple frequency embodiment. Anti-resonant frequency fa1 903 of graph 901 is designed to be approximately equal to resonant frequency fr2 904 of graph 902; and anti-resonant frequency fa3 913 of graph 901 is designed to be approximately equal to resonant frequency fr4 914 of graph 902. This results in four new resonant frequencies fx 1 905, fy 1 906, fx3 915, and fy3 916 where L1 907 resonates with C2 908 at fx 1 905, where L2 909 resonates with C1 910 at fy1 906, where L3 917 resonates with C4 918 at fx3 915, where L4 919 resonates with C3 920 at fy3 916. New resonant frequency fx 1 905 is located approximately half way between resonant frequency fr1 921 and resonant frequency fr2 904. New resonant frequency fy 1 906 is located approximately half way between anti-resonant frequency fa1 903 and anti-resonant frequency fa2 923. New resonant frequency fx3 915 is located approximately half way between resonant frequency fr3 922 and resonant frequency fr4 914. New resonant frequency fy3 916 is located approximately half way between anti-resonant frequency fa3 913 and anti-resonant frequency fa4 924. Approximately sinusoidal shaped waveforms are formed at fx 1 905, fy 1 906, fx3 915, and fy3 916 by the assembly when driven at each frequency fx1 905, fy 1 906, fx3 915, and fy3 916 respectively.

The symbols for FIG. 9 indicate odd harmonic resonances, however, the same shaped plots exists for components with both odd and even harmonics or overtones.

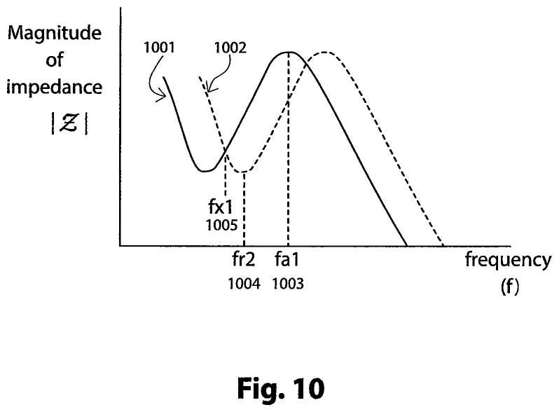

FIG. 10 is magnitude of impedance |Z| versus frequency f graphs 1001 and 1002 of two components in an assembly according to an embodiment. Anti-resonant frequency fa1 1003 of graph 1001 is designed to be higher than resonant frequency fr2 1004 of graph 1002. This results in a larger bandwidth of inductive characteristic for the new resonance fx1 1005. This is the best load for sweeping bridge circuits.

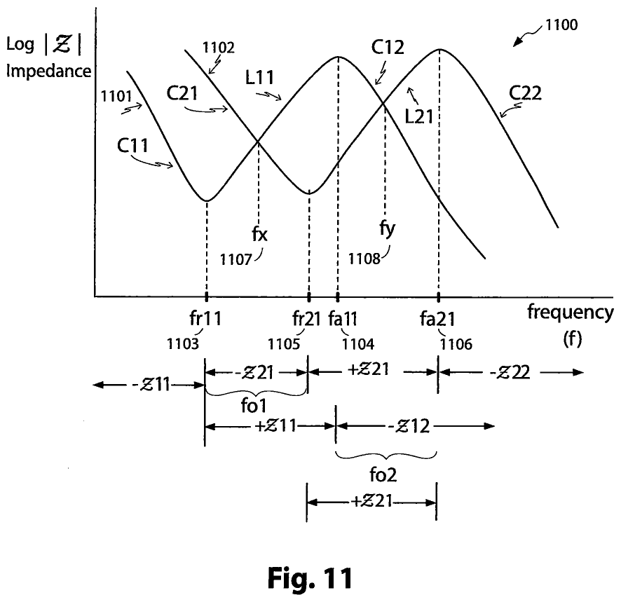

FIG. 11 is log magnitude of impedance |Z| versus frequency f graphs 1100 of two components 1101 and 1102 according to Assembly G. fr11 1103 is the resonant frequency of component 1101 and fa11 1104 is the anti-resonant frequency of component 1101. fr21 1105 is the resonant frequency of component 1102 and fa21 1106 is the anti-resonant frequency of component 1102. fx 1107 and fy 1108 are new resonant frequencies formed by the series assembly of components 1101 and 1102.

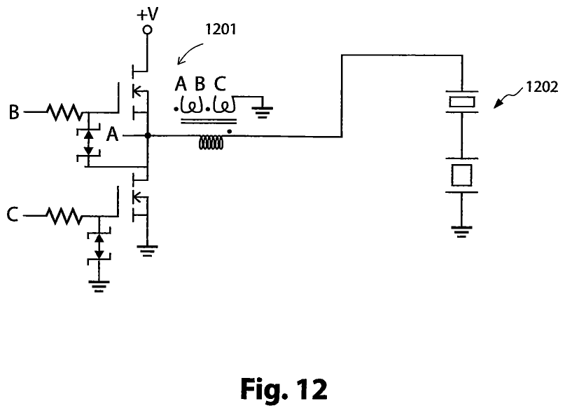

FIG. 12 is shows a self oscillator circuit 1201driving an inventive assembly 1202.

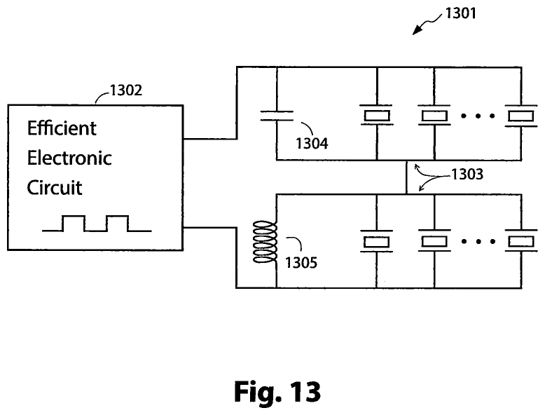

FIG. 13 shows a typical diagram for Assembly H 1301. Efficient electronic circuit 1302 drives series assembly 1303 containing capacitor 1304 and inductor 1305

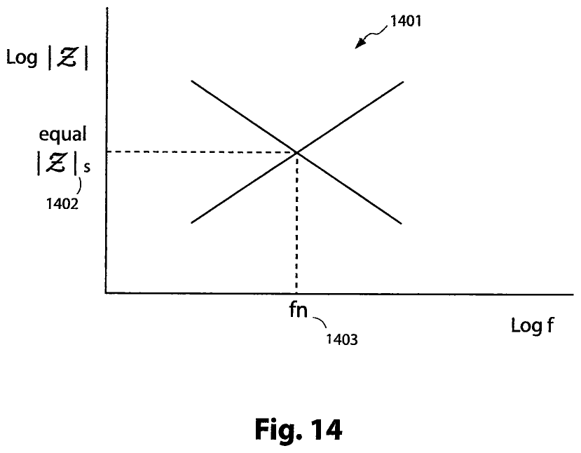

FIG. 14 shows the characteristic 1401 for Assembly J where the magnitude of the two impedances are equal at new resonant frequency fn 1403.

What is claimed is:

1. An assembly comprising:
A first component designed to have a resonant frequency (fr11) and a higher anti-resonant frequency (fa11), wherein said first component exhibits a negative reactive impedance frequency range below fr11 (referred to as frequency range −Z11), a positive reactive impedance frequency range between fr11 and fa11 (referred to as frequency range+Z11), and a negative reactive impedance frequency range above fa11 (referred to as frequency range −Z12).
A second component designed to have a resonant frequency (fr21) greater than fr11, a higher anti-resonant frequency (fa21), a negative reactive impedance frequency range below fr21 (referred to as frequency range −Z21), a positive reactive impedance frequency range between fr21 and fa21 (referred to as frequency range+Z21), and a negative reactive impedance frequency range above fa21 (referred to as frequency range-Z22), wherein the design of the second component further requires some or all of frequency range −Z21 overlaps some or all of frequency range+Z11 (referred to as overlapping frequency range delta fo1), and some or all of frequency range+Z21 overlaps some or all of frequency range −Z12 (referred to as overlapping frequency range delta fo2).
In said overlapping frequency range delta fo1, the design of the second component is such as to produce a frequency (fx) where the magnitude of the negative reactive impedance at fx of said second component equals the magnitude of the positive reactive impedance of said first component at fx.
In said overlapping frequency range delta fo2, the design of the second component is such as to produce a frequency (fy) where the magnitude of the positive reactive impedance at fy of said second component equals the magnitude of the negative reactive impedance of said first component at fy.
The first component is connected in series with the second component forming an assembly having three nodes, the center node called the series connection center node and the two other nodes are called the outside nodes, whereas between the two outside nodes are produced a first new resonant frequency at fx and a second new resonant frequency at fy where fx and fy are also series resonant frequencies and where fx is greater than fr11 and fy is greater than fr21.

2. The assembly of claim 1, further comprising an efficient electronic circuit coupled or connected to the outside nodes of the assembly, wherein the efficient electronic circuit is designed or programmed to drive the assembly at the first new resonant frequency fx, the second new resonant frequency fy, or to alternately drive the assembly at the first new resonant frequency fx and at the second new resonant frequency fy.

3. The assembly of claim 1, further comprising an efficient electronic circuit coupled or connected to the outside nodes of the assembly, wherein the efficient electronic circuit is designed or programmed to drive the assembly through one or more sweeping frequency bandwidths each containing one or more new resonant frequencies (fx and/or fy).

4. The assembly according to claim 1 wherein the first component also contains one or more additional harmonic or overtone frequency regions, and the second component is designed to also satisfy the claim 1 characteristics in this one or more harmonic or overtone frequency regions forming additional new resonant frequencies.

5. The assembly of claim 4, further comprising an efficient electronic circuit coupled or connected to the outside nodes of the assembly, wherein the efficient electronic circuit is designed or programmed to drive the assembly at any one or more of the new resonant frequencies.

6. The assembly of claim 4, further comprising an efficient electronic circuit coupled or connected to the outside nodes of the assembly, wherein the efficient electronic circuit is designed or programmed to drive the assembly through one or more sweeping frequency bandwidths each containing one or more new resonant frequencies.

7. The assembly of claim 1, further comprising an oscillator circuit coupled or connected to the outside nodes of the assembly, wherein the oscillator circuit is designed to drive the assembly at the first new resonant frequency fx, the second new resonant frequency fy, or to alternately drive the assembly at the first new resonant frequency fx and at the second new resonant frequency fy.

8. The assembly of claim 4, further comprising an oscillator circuit coupled or connected to the outside nodes of the assembly, wherein the oscillator circuit is designed to drive the assembly at one or more of the new resonant frequencies or sweeping around one or more of the new resonant frequencies.

9. The assembly of claim 1, wherein the series connection center node is floating, connected to ground, or interconnected with other series connection center nodes.

10. An assembly comprising:
A first component consisting of an array of paralleled Langevin transducers for frequencies up to 350 kHz or an array of paralleled piezoelectric ceramics for megasonic frequencies connected in parallel with a capacitor.
A second component consisting of an array of paralleled Langevin transducers for frequencies up to 350 kHz or an array of paralleled piezoelectric ceramics for megasonic frequencies connected in parallel with an inductor.
The first component is connected in series with the second component forming an assembly having three nodes, the center node called the series connection center node and the two other nodes are called the outside nodes, whereas between the two outside nodes is produced a series resonant frequency.

11. The assembly of claim 10, further comprising an efficient electronic circuit coupled or connected to the outside nodes of the assembly, wherein the efficient electronic circuit is designed or programmed to drive the assembly at the series resonant frequency.

12. The assembly of claim 10, further comprising an efficient electronic circuit coupled or connected to the outside nodes of the assembly, wherein the efficient electronic circuit is designed or programmed to drive the assembly sweeping through a bandwidth of frequencies containing the series resonant frequency.

13. The assembly of claim 10, wherein the series connection center node is floating, connected to ground, or interconnected with each other series connection center nodes.

14. The assembly of claim 10, further comprising an oscillator circuit coupled or connected to the outside nodes of the assembly, wherein the oscillator circuit is designed to drive the assembly at the series resonant frequency or sweeping around the series resonant frequency.

15. The assembly of claim 10 where said parallel capacitor and said parallel inductor are remotely located.

16. An assembly comprising:
Two different frequency components each containing one or more piezoelectric ceramics are connected in series to form an assembly, that assembly having three nodes, the center node called the series connection center node and the two other nodes are called the outside nodes, whereas each component is designed to have one or more reactive frequency regions such that there exists one or more frequencies in said one or more reactive frequency regions where the magnitude of the reactive impedance of one component equals the magnitude of the opposite reactive impedance of the other component at a frequency in an overlapping negative reactive impedance frequency region and positive reactive impedance frequency region. Whereas one or more new resonant frequencies which are also series resonant frequencies are formed in the assembly between the outside nodes of the assembly. Whereas one or more of these new resonant frequencies are driven by an efficient electronic circuit that supplies a drive voltage at a new resonant frequency or at a sweeping bandwidth of frequencies containing a new resonant frequency. Whereas the approximately square wave shaped waveform from the efficient electronic circuit is converted by the assembly into approximately sinusoidal shaped waveforms to each component, these approximately sinusoidal shaped waveforms having the proper phase for driving each component to produce ultrasound.

17. The assembly of claim 1, further comprising an efficient electronic circuit with its approximately square wave shaped waveform output connected to one end of a transmission line with impedance Zt, the other end of the transmission line is connected to the primary of an impedance matching transformer that transforms Zt to Zx, the resistive impedance of a new resonance. The secondary of the impedance matching transformer is connected to the assembly or array of parallel assemblies having the new resonance with impedance Zx.
